(19) United States
(12) Patent Application Publication
(10) Pub. No.: US 2008/0252695 A1
(43) Pub. Date: Oct. 16, 2008

(54) DROPLET DISCHARGE HEAD, DROPLET DISCHARGE DEVICE, AND DISCHARGE CONTROLLING METHOD THEREOF

(75) Inventors: Akira Sano, Matsumoto (JP); Junichiro SHINOZAKI, Chino (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/057,998

(22) Filed: Mar. 28, 2008

(30) Foreign Application Priority Data
Apr. 13, 2007 (JP) 2007-105886

(51) Int. Cl. B41J 2/04

(52) U.S. Cl. 347/54

(57) ABSTRACT

A droplet discharge head includes: a nozzle; a plurality of discharge chambers each of which is provided with a respective one of a plurality of vibrating plates to be displaced so as to pressurize a liquid, and formed in series in a flow channel, communicating with the nozzle, of the liquid; and a fixed electrode that is opposed to each of the vibrating plates of each of the discharge chambers and generates an electrostatic force for displacing each of the vibrating plates. In the droplet discharge head, removing volumes removed by the displacement of the vibrating plates are different from each other.

### BACKGROUND

1. Technical Field

The present invention relates to a droplet discharge head, and a droplet discharge device and the like including the droplet discharge head.

2. Related Art

Micro electro mechanical systems (MEMS) by which silicon, for example, is processed to produce fine elements and the like have rapidly advanced. Examples of fine processed elements that are produced by MEMS include: a droplet discharge head (inkjet head) employed in a recording (printing) device such as a printer in droplet discharge system; a micro pump; an optical variable filter; an electrostatic actuator such as a motor; and a pressure sensor.

The droplet discharge system (a typical example is ink-jetting by which an ink is discharged for printing or the like) is employed in printing in various fields for household use and for industrial use. In the droplet discharge system, a droplet discharge head including a plurality of nozzles that are fine processed elements, for example, is relatively moved with respect to an object so as to discharge a liquid on a predetermined position of the object. The droplet discharge system has been employed to manufacture a color filter for manufacturing a display employing liquid crystal, a displaying substrate (OLED) employing an organic electroluminescence elements, a microarray for a biomolecule such as DNA, in recent years.

There is a discharge head for realizing the droplet discharge system. The discharge head is structured such that at least one wall (It is a bottom wall, for example. The wall is unified with other walls, but this wall will be referred to as a vibrating plate, hereinafter.) of a discharge chamber for storing a discharge liquid on a flow channel is formed to bend and change its shape. The vibrating plate is bended to increase a pressure within the discharge chamber and thus the droplet is discharged from the nozzles communicating with the discharge chamber.

In a case of a droplet discharge head in an electrostatic system disclosed in JP-A-2005-007735, for example, an electrostatic force is generated between a vibrating plate that is a movable electrode and an individual electrode that is a fixed electrode opposed to the vibrating plate so as to attract the vibrating plate toward the individual electrode. Then if the electrostatic force is reduced or the generation thereof is stopped, the vibrating plate is displaced to an original position due to a restring force (an elastic force) by which the vibrating plate returns to an equilibrium state. By repeating these steps, the vibrating plate is driven, discharging a droplet.

As described above, even though the vibrating plate vibrates, many droplet discharge heads can basically control only in an alternative manner, that is, whether an electric charge is supplied to each individual electrode or not is essentially controlled. However, it is desirable that various controls can be conducted in droplet discharge heads in order to achieve a high-quality image and high-speed printing. It is highly required to change a liquid discharge amount (hereinafter, referred to as a discharge amount) for each landing position, or to control an electrostatic actuator corresponding to each nozzle so as to discharge stably.

There is such a method that a liquid in a discharge chamber is slightly vibrated, for example, and the liquid is pressurized by resonance with respect to the vibration so as to discharge the liquid. Here, each cycle of the slight vibration may be different depending on manufacturing variation of the droplet discharge heads, so that it is hard to set a driving waveform (applying voltage) for generating resonance in each head. Alternatively, there is such a method that an individual electrode is formed step-like so as to control a vibrating plate to be displaced in accordance with each step, and thus a discharge amount is changed based on the displacement. Here, if the step is small, the variation of the discharge amount is small as well. However, if a distance between the individual electrode and the vibrating plate is increased, the electrostatic force decreases or electric consumption increases, being hard to widen a range of the variation of the discharge amount.

### SUMMARY

An advantage of the present invention is to provide a droplet discharge head and the like that can conduct a discharge control such as an efficient change of a discharge amount.

A droplet discharge head according to a first aspect of the invention, includes: a nozzle; a plurality of discharge chambers each of which is provided with a respective one of a plurality of vibrating plates to be displaced so as to pressurize a liquid, and formed in series in a flow channel, communicating with the nozzle, of the liquid; and a fixed electrode that is opposed to each of the vibrating plates of each of the discharge chambers and generates an electrostatic force for displacing each of the vibrating plates. In the droplet discharge head, removing volumes removed by the displacement of the vibrating plates are different from each other.

According to the first aspect, the plurality of discharge chambers including the plurality of vibrating plates are provided in the flow channel with respect to the nozzle such that the removing volumes removed by a displacement are different from each other. The vibrating plates are displaced by an electrostatic force generated by the fixed electrode so as to pressurize and discharge the liquid. Therefore, by arranging a control of the vibrating plates, a plurality of discharge amounts can be separately controlled at one discharge.

In the droplet discharge head of the first aspect, the fixed electrode may be provided in a plurality of numbers, and each of the fixed electrodes may be wired individually and be opposed to each of the vibrating plates.

According to the aspect, if timings for displacing the vibrating plates differ from each other, the discharge amount can be largely changed.

In the droplet discharge head of the first aspect, two substrates on which the plurality of fixed electrodes are divided to be provided may be each bonded on both surfaces of a substrate provided with the plurality of discharge chambers.

According to the aspect, since the plurality of fixed electrodes are divided to be provided on the two substrates, the number of the fixed electrodes and the number of the wiring can be reduced compared to a case where the fixed electrodes are provided on one substrate. Therefore, the discharge amount can be changed by the plurality of vibrating plates and the miniaturization of the droplet discharge head can be achieved.

In the droplet discharge head of the first aspect, the nozzle may be provided to an edge face of the head.

According to the aspect, since the nozzle is provided on the edge face of the head, the droplet can be discharged from the edge face even though the substrates including the fixed electrodes are provided on the both surfaces of the droplet discharge head. Manufacturing thereof is easier than that of a case where a nozzle is formed on a substrate including a fixed electrode.

In the droplet discharge head of the first aspect, a removing volume removed by the displacement of a vibrating plate that is formed at a closer side to the nozzle may be smaller.

According to the aspect, the removing volume removed by the vibrating plate that is provided to the side closer to the nozzle is smaller. Therefore, in a case of a control to discharge a droplet by the displacement of the vibrating plate that is provided to the side closer to the nozzle, the discharge amount can be more reduced. Thus, a range of the variation of the discharge amount can be widened.

In the droplet discharge head of the first aspect, the vibrating plates may be allowed to have at least one of different lengths and different widths from each other so as to make removing volumes removed by the displacement of the vibrating plates different from each other.

According to the aspect, the vibrating plates are allowed to have different lengths and/or widths so as to make the removing volumes different from each other. Therefore, if the vibrating plates are formed to have different lengths and/or widths in a desired rate and the like, the amounts of discharge executed by the displacement of the respective vibrating plates can be adjusted.

In the droplet discharge head of the first aspect, gaps between the vibrating plates and the fixed electrodes may be formed to differ from each other at an initial state and thus removing volumes removed by the displacement of the vibrating plates may be made different from each other.

According to the aspect, the gaps between the vibrating plates and the fixed electrodes are formed to differ from each other at the initial state and thus the removing volumes are made different from each other. Therefore, if the vibrating plates and the fixed electrodes are formed to have gaps therebetween corresponding to a desired ratio and the like at the initial state, the amounts of discharge executed by the displacement of the respective vibrating plates can be adjusted.

A droplet discharge device according to a second aspect of the invention, includes the droplet discharge head of the first aspect.

According to the second aspect, since the droplet discharge device is provided with the droplet discharge head of the first aspect, the discharge amount can be controlled. Therefore, the device can achieve a high-quality image in a case where it is used for image printing, for example.

According to a third aspect of the invention, a method for controlling a discharge of a droplet discharge head which includes: two discharge chambers that are provided in series in a flow channel communicating with a nozzle and are provided with respective one of two vibrating plates to be displaced to pressurize a liquid; and two fixed electrodes that generate an electrostatic force based on a potential difference and displace the two vibrating plates having different removing volumes removed by a displacement so as to pressurize the liquid, includes: a) generating an electrostatic force between a downstream side vibrating plate that is closer to the nozzle and is one of the vibrating plates each included to the two discharge chambers and a downstream side fixed electrode so as to apply a pressure for discharging a droplet; and b) generating an electrostatic force between an upstream side vibrating plate that is the other vibrating plate and an upstream side fixed electrode, and thus drawing the upstream side vibrating plate toward the upstream side fixed electrode so as to draw a posterior end of the liquid to be discharged from the nozzle as a droplet into the flow channel.

According to the third aspect, since the posterior end of the liquid to be discharged from the nozzle is drawn into the flow channel, the discharge amount of the droplet can be controlled to be reduced compared to the normal discharge.

According to a fourth aspect of the invention, a method for controlling a discharge of a droplet discharge head which includes two discharge chambers that are provided in series in a flow channel communicating with a nozzle and are provided with respective one of two vibrating plates to be displaced to pressurize a liquid; and two fixed electrodes that generate an electrostatic force based on a potential difference and displace the two vibrating plates having different removing volumes removed by a displacement so as to pressurize the liquid, includes: c) drawing an upstream side vibrating plate that is farther from the nozzle and is one of the vibrating plates each included to the two discharge chambers toward an upstream side fixed electrode, and keeping the state; and d) generating an electrostatic force between a downstream vibrating plate that is the other vibrating plate and a downstream side fixed electrode, and thus drawing the downstream side vibrating plate toward the downstream side fixed electrode so as to apply a pressure for discharging a droplet by the downstream side vibrating plate and an upstream side vibrating plate.

According to the fourth aspect, after the upstream side vibrating plate is drawn toward the upstream side fixed electrode to be kept in the state, a pressure is applied to the liquid by the downstream side vibrating plate and the upstream side vibrating plate. Therefore, the force applying from the discharge chamber (the downstream side discharge chamber) including the downstream side vibrating plate toward the discharge chamber (the upstream side discharge chamber) can be suppressed and thus the force toward the nozzle can be increased, so that the discharge amount can be controlled to be increased compared to the normal discharge.

According to a fifth aspect of the invention, a method for controlling a discharge of a droplet discharge head which includes two discharge chambers that are provided in series in a flow channel communicating with a nozzle and are provided with respective one of two vibrating plates to be displaced to pressurize a liquid; and two fixed electrodes that generate an electrostatic force based on a potential difference and displace the two vibrating plates having different removing volumes removed by a displacement so as to pressurize the liquid, includes: e) drawing a downstream side vibrating plate that is closer the nozzle and is one of the vibrating plates each included to the two discharge chambers toward a downstream side fixed electrode so as to increase a bulk of the downstream side discharge chamber, and keeping this state until a liquid is supplied to the downstream side discharge chamber; and f) generating an electrostatic force between an upstream vibrating plate that is the other vibrating plate and an upstream side fixed electrode, and thus drawing the upstream side vibrating plate toward the upstream side fixed electrode so as to apply a pressure for discharging a droplet by the downstream side vibrating plate and the upstream side vibrating plate.

According to the fifth aspect, after the downstream side vibrating plate is drawn toward the downstream side fixed electrode so as to increase the amount of the liquid stored in the downstream side discharge chamber, a pressure for a droplet discharge is applied to the liquid by the downstream side vibrating plate and the upstream side vibrating plate. Therefore, the discharge amount of the droplet can be controlled to be increased compared to the normal discharge.

According to a sixth aspect of the invention, a method for controlling a discharge of a droplet discharge head which includes two discharge chambers that are provided in series in a flow channel communicating with a nozzle and are provided with respective one of two vibrating plates to be displaced to pressurize a liquid; and two fixed electrodes that generate an electrostatic force based on a potential difference and displace the two vibrating plates having different removing volumes removed by a displacement so as to pressurize the liquid, includes: g) generating an electrostatic force between a downstream side vibrating plate that is closer to the nozzle and is one of the two vibrating plates each included to the two discharge chambers and a downstream side fixed electrode so as to apply a pressure for discharging a droplet; and h) generating an electrostatic force between an upstream side vibrating plate that is the other vibrating plate and an upstream side fixed electrode after a droplet is discharged from the nozzle so as to generate a vibration that cancels a natural vibration of the liquid in the flow channel, on the upstream side vibrating plate.

According to the sixth aspect, since a vibration for canceling the natural vibration is generated on the upstream side vibrating plate so as to suppress the residual vibration after a droplet discharge, the liquid and the vibrating plate in the flow channel can be stabilized to shorten the time for one discharge, achieving the speed up. Especially, the upstream side vibrating plate is not displaced and does not overshoot like the downstream side vibrating plate, so that the electrostatic force required for suppressing the residual vibration can be generated on the upstream side vibrating plate directly after the discharge.

According to a seventh aspect of the invention, a method for controlling a discharge of a droplet discharge device includes controlling a discharge by applying the method for controlling a discharge of a droplet discharge head of the above aspects.

According to the seventh aspect, since the method for controlling a discharge of a droplet discharge device employs the method for controlling a discharge of a droplet discharge head, the droplet discharge device can achieve a high-quality image thereof by controlling the discharge amount in a case where it is used for image printing, for example. Further, since time spent for one position can be especially reduced, the device can achieve a high speed in a process such as printing. Especially the discharge interval can be shortened, the device can achieve a high speed in a process such as printing.

### BRIEF DESCRIPTION OF THE DRAWINGS

The invention will be described with reference to the accompanying drawings, wherein like numbers reference like elements.

FIG. 1 is an exploded diagram showing a droplet discharge head according to a first embodiment.

FIG. 2 is a sectional view showing the droplet discharge head of the first embodiment.

FIG. 3 is a configuration diagram mainly showing a driving control circuit 40.

FIGS. 4A to 4E are diagrams showing an example of a forming process of an electrode substrate 10.

FIGS. 5A to 5G are diagrams showing a manufacturing process of a droplet discharge head.

FIG. 6 is a sectional view showing a droplet discharge head according to a third embodiment.

FIG. 7 is a sectional view showing a droplet discharge head according to a fourth embodiment.

FIG. 8 is an external view showing a droplet discharge device employing a droplet discharge head.

FIG. 9 is a diagram showing an example of main structural means of a droplet discharge device.

### DESCRIPTION OF EXEMPLARY EMBODIMENTS

### First Embodiment

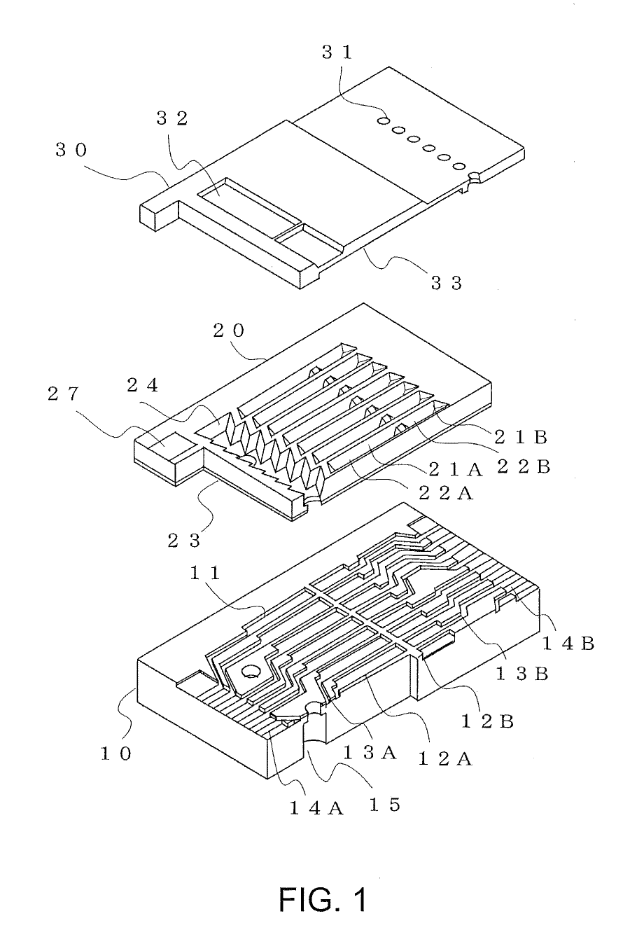

FIG. 1 is an exploded diagram showing a droplet discharge head according to a first embodiment of the invention. FIG. 1 shows a part of the droplet discharge head. The present embodiment describes a face eject type droplet discharge head. In the droplet discharge head, a plurality of electrostatic actuators are integrated so as to produce an image by discharging a droplet, for example. Note that the relation between constitutional elements may different from that between actual ones in the following drawings to show the elements clear. In the drawings, the topside is described as up, and the bottom side is described as down.

As shown in FIG. 1, this droplet discharge head of the present embodiment is formed by layering three substrates: an electrode substrate 10, a cavity substrate 20, and a nozzle substrate 30 from the bottom in this order. The electrode substrate 10 is anode-bonded to the cavity substrate 20 in the embodiment. The cavity substrate 20 is bonded to the nozzle substrate 30 with an epoxy resin adhesive, for example.

The electrode substrate 10 is, for example, primarily made of heat resistant hard glass such as borosilicate glass and has a 1 mm thickness. The electrode substrate 10 is a glass substrate in the present embodiment, but may be a single-crystalline silicon substrate, for example. On a surface of the electrode substrate 10, a plurality of recesses 11 having a depth of about 0.3 μm, for example, are formed. In the recesses 11 (especially, at bottom parts), two individual electrodes (fixed electrodes) are provided so as to be opposed to an upstream side discharge chamber 21A (an upstream side vibrating plate 22A) and a down stream side discharge chamber 21B (a downstream side vibrating plate 22B) of the cavity substrate 20. An individual electrode provided on the upstream side (a side closer to a reservoir 24) with respect to a liquid flow is called an upstream side individual electrode 12A. To the upstream side individual electrode 12A, an upstream side lead 13A and an upstream side terminal 14A are provided in a unified manner (Hereinafter, these all are called the upstream side individual electrode 12A unless they have to be especially discriminated from each other.). An individual electrode provided on the downstream side with respect to a liquid flow is called a downstream side individual electrode 12B. To the downstream side individual electrode 12B, a downstream side lead 13B and a downstream side terminal 14B are provided in a unified manner (Hereinafter, these all are called the downstream side individual electrode 12B unless they have to be especially discriminated from each other.). Further, if the upstream side individual electrode 12A and the downstream side individual electrode 12B do not need to be discriminated from each other, they are called individual electrodes 12. Between the upstream side vibrating plate 22A (the downstream side vibrating plate 22B) and the upstream side individual electrode 12A (the downstream side individual electrode 12B), a predetermined gap (space) in which the upstream side vibrating plate 22A (the downstream side vibrating plate 22B) can bend (be displaced) is formed by the recesses 11. The upstream side individual electrode 12A and the downstream side individual electrode 12B are formed by layering an ITO having a thickness of 0.1 μm in the inside of the recesses 11 by a sputtering method, for example. The electrode substrate 10 is provided with a through hole to be a liquid supply inlet 15 that is a flow channel for taking in a liquid supplied from an external tank (not shown).

The cavity substrate 20 is primarily composed of a single-crystalline silicon substrate (hereinafter, referred to as a silicon substrate) having a surface of (110) plane orientation, for example. The cavity substrate 20 is provided with recesses (each bottom wall is the upstream side vibrating plate 22A and the downstream side vibrating plate 22B that are movable electrodes) that temporarily store a discharged liquid and are to be the upstream side discharge chamber 21A and the downstream side discharge chamber 21B and a recess to be the reservoir 24 (If the upstream side discharge chamber 21A and the downstream side discharge chamber 21B do not need to be discriminated from each other, they are called discharge chambers 21. In the same manner, if the upstream side vibrating plate 22A and the downstream side vibrating plate 22B do not need to be discriminated from each other, they are called vibrating plates 22). In this embodiment, the upstream side discharge chamber 21A and the downstream side discharge chamber 21B have different lengths from each other in a longitudinal direction. Therefore, removing volumes (bulk that the discharge chambers 21 enlarge) removed when the vibrating plates 22 bend toward the individual electrode 21 side are different from each other. The upstream side vibrating plate 22A and the downstream side vibrating plate 22B of the present embodiment have a width (a length in a shorter direction) of about 100 μm and a thickness of about 2 μm. The upstream side vibrating plate 22A has a length of about 2 mm, and the downstream side vibrating plate 22B has a length of about 1 mm. However, they are not limited to the above. Here, a ratio between the length of the upstream side vibrating plate 22A and that of the downstream side vibrating plate 22B is 2:1, but it may be 3:2, for example. Thus the length and the ratio are not limited. In addition, the widths of the vibrating plates 22 are same as each other in the present embodiment, but they are not limited. The widths may be different and accordingly the removing volumes may be different from each other.

On a back surface (a surface facing the electrode substrate 10) of the cavity substrate 20, an insulating film 23 having a thickness of 0.1 μm (100 nm) and composed of a TEOS film (a SiO₂ film obtained by using tetraethyl orthosilicate tetraethoxysilane (ethyl silicate) as a material gas) is formed so as to electrically insulate between the cavity substrate 20 and the individual electrodes 12. The insulating film 23 is composed of the TEOS film in this embodiment, but it may be made of Al₂O₃ (alumina), for example. Further, a recess to be the reservoir (a common liquid chamber) 24 that supplies a liquid to each of the discharge chambers 21 is formed on the cavity substrate 20. Further, the cavity substrate 20 is provided with the common electrode terminal 27 that is a terminal for supplying charge from an external power supply means (not shown) to the cavity substrate 20 (the vibrating plates 22).

The nozzle substrate 30 is also primarily composed of a silicon substrate, for example. The nozzle substrate 30 is provided with a plurality of nozzles 31. Each of the nozzles 31 discharges a liquid pressurized by displacement of the vibrating plates 22 to outside in a droplet. In the present embodiment, holes of the nozzles 31 are formed in a plurality of stages so as to achieve the straightness of flying of the discharged droplet. Further, the nozzle substrate 30 is provided with a diaphragm 32 buffering a pressure that is produced by the bend of the vibrating plates 22 and is applied in the reservoir 24 direction. Furthermore, the nozzle substrate 30 is provided with an orifice 33 to be a groove for allowing the downstream side discharge chamber 21B and the reservoir 24 to communicate with each other.

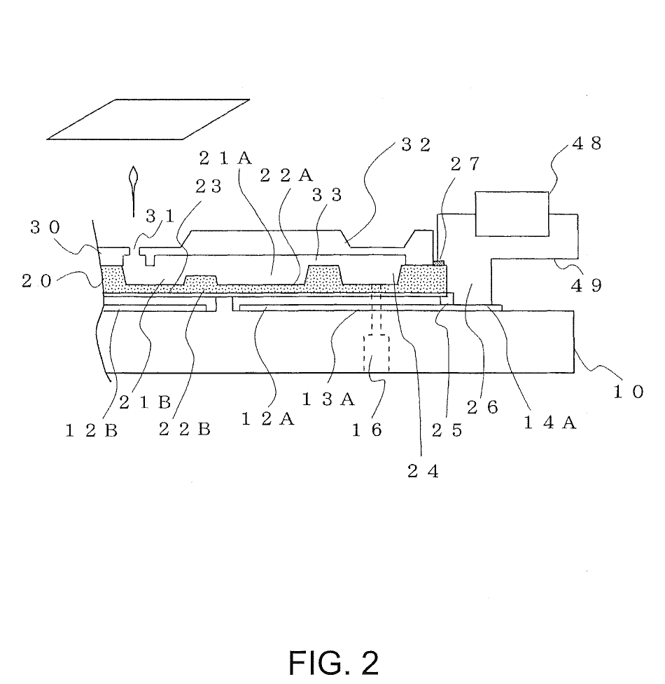

FIG. 2 is a sectional view of a droplet discharge head. Referring to FIG. 2, the discharge chambers 21 store a liquid to be discharged from the nozzles 31. The vibrating plates 22 that are the bottom walls of the discharge chambers 21 are allowed to bend and thus a pressure within the discharge chambers 21 is increased so as to discharge a droplet from the nozzles 31. In the present embodiment, two discharge chambers 21 (the upstream side discharge chamber 21A and the downstream side discharge chamber 21B) and two vibrating plates 22 (the upstream side vibrating plate 22A and the downstream side vibrating plate 22B) are formed on the flow channel communicating with each of the nozzles 31. Timings of the displacement (contact and separate) of the two vibrating plates are controlled so as to change the discharge amounts of the droplet discharged from the nozzles 31. The nozzle substrate 30 is provided with a sealing member 25 at an electrode extracting port 26 so as to block the gap from the outside air and seal the gap, preventing foreign substance or water (moisture vapor) from entering the gap.

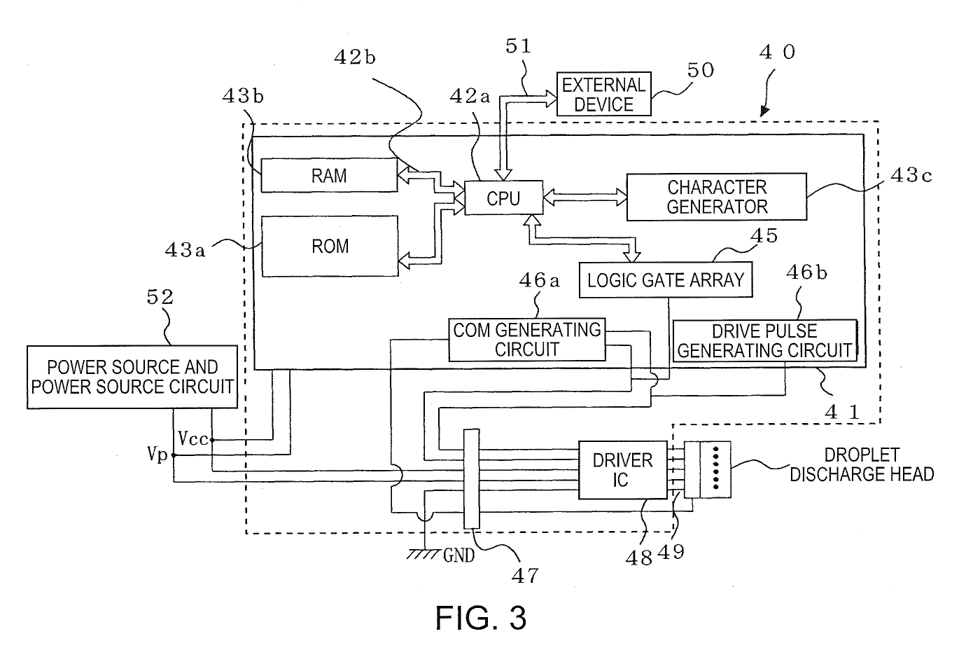

FIG. 3 is a configuration diagram mainly showing a driving control circuit 40. Referring to FIG. 3, a controlling system and the like for discharging a liquid from the droplet discharge head by contacting and separating the vibrating plates 22 will be described. The driving control circuit 40 includes a head controller 41 provided with a central processing unit (CPU) 42a as a major part. To the CPU 42a of the head controller 41, a signal including a printing data and the like is inputted from an external device 50 such as a computer through a bus 51.

To the head controller 41, a ROM 43a, a RAM 43b, and a character generator 43c are provided and are coupled through an internal bus 42b to the CPU 42a. The CPU 42a executes a process in accordance with a controlling program stored in the ROM 43a so as to generate a discharge control signal corresponding to the printing data. At this time, a storage area in the RAM 43b is used as a work area, and in a case of printing letters, for example, a process based on character data stored in the character generator 43c. The discharge control signal generated by the CPU 42a is sent to a logic gate array 45 through the internal bus 42b. As described later, the logic gate array 45 generates a signal on a charge supply with respect to the individual electrodes 12 in accordance with the discharge control signal. A COM generating circuit 46a generates a signal on a charge supply with respect to the cavity substrate 20 (the vibrating plates 22), as described later. A drive pulse generating circuit 46b generates a signal for synchronous. These signals are sent to a driver IC 48 through a connector 47.

A driver IC 48 is electrically coupled to the upstream side terminal 14A, the downstream side terminal 14B, and the common electrode terminal 27 directly or through a flexible print circuit (FPC), a wiring 49 such as a wire, or the like. If the number of terminals of the driver IC 48 is smaller than the number of the nozzles 31 of the droplet discharge head, the driving control circuit 40 may include a plurality of driver ICs 48. The driver IC 48 receives a power supply from a power source circuit 52 (a voltage is applied) so as to actually conduct a start (charging), a retention, and a discharge of the charge supply with respect to the cavity substrate 20 (the vibrating plates 22) and the individual electrodes 12 based on the signals described above. By repeating a supply, retention, and a discharge of the electric charge, potential difference is generated such that electric charge is supplied to the cavity substrate 20 side and, on the other hand, charge is not supplied to the individual electrodes 12 side, for example.

The voltage apply generates an electrostatic force between the vibrating plates 22 and the individual electrodes 12, so that the vibrating plates 22 gravitate toward the individual electrodes 12 side to bend and contact the individual electrodes 12. Accordingly, a bulk of the discharge chamber 21 increases. If the generation of the electrostatic force is stopped, the vibrating plates 22 separate from the individual electrodes 12 so as to return to the original position. At this time, a pressure obtained by a restring force (hereinafter, referred to as a restring pressure) is applied to the liquid, and thus the liquid is pushed to be discharged from the nozzles 31. The discharged droplet is columnar and is connected with the droplet discharge head (nozzles 31) at first, and then becomes spherical due to surface tension of the liquid and the like to separate from the droplet discharge head. If this droplet lands on a recording paper that is a recording target, the recording such as printing is executed. At this time, if timings of the voltage apply or the like are controlled and thus timings of contacting or separating of the upstream side vibrating plate 22A and the downstream side vibrating plate 22B are changed, the discharge amounts can be changed, for example. Here, the generation of the electrostatic force is stopped and thus the vibrating plates 22 are separated from the individual electrodes 12, but the electrostatic force may be adjusted without completely stopping the generation thereof. If the electrostatic force is adjusted and thus the velocity that the vibrating plates 22 separate is adjusted, pressurization of the vibrating plates 22 with respect to the liquid can be controlled.

Examples of the control, conducted by the driving control circuit 40, with respect to a discharge amount from the nozzles 31 will be next described. In the present embodiment, the droplet discharge is controlled by controlling modes 1 to 5 depending on a discharge amount from the nozzles 31. The embodiment describes the controls of five modes, but the number of the mode is not limited to this. Timings of contacting and separating of the upstream side vibrating plate 22A and the downstream side vibrating plate 22B are not limited to those in the respective modes, but other timings can be set.

Mode 1

Electrostatic force is generated between the downstream side individual electrode 12B and the downstream side vibrating plate 22B so as to contact them. Then the downstream side vibrating plate 22B is separated from the downstream side individual electrode 12B so as to pressurize the liquid, discharging the droplet from the nozzles 31. As described above, the droplet that is discharged has a columnar shape and is connected with the droplet discharge head at first. Here, electrostatic force is generated between the upstream side individual electrode 12A and the upstream side vibrating plate 22A before the liquid is separated from the droplet discharge head, so as to bring the upstream side vibrating plate 22A into contact with the upstream side individual electrode 12A. A leading end of the liquid that is pressurized by restoring pressure is separated from the head while keeping the force of the pressurization, and, on the other hand, the posterior end of the liquid is drawn into the discharge chamber 21B (nozzles 31). Thus the posterior end of the droplet is forced to separate as above. Therefore, the discharge amount (a size of a droplet) can be controlled to be reduced compared to a usual discharge.

Mode 2

Electrostatic power is generated between the downstream side individual electrode 12B and the downstream side vibrating plate 22B so as to contact them. Then the downstream side vibrating plate 22B is separated from the downstream side individual electrode 12B so as to pressurize the liquid. Unlike the mode 1, the liquid is discharged without drawing the posterior end of the droplet by contacting the upstream side vibrating plate 22A and the upstream side individual electrode 12A. Thus, the upstream side vibrating plate 22A does not contact and separate.

Mode 3

Electrostatic force is generated between the upstream side individual electrode 12A and the upstream side vibrating plate 22A in advance, and thus the upstream side vibrating plate 22A is kept to contact the upstream side individual electrode 12A. Then electrostatic power is generated between the downstream side individual electrode 12B and the downstream side vibrating plate 22B so as to contact them. After that, the downstream side vibrating plate 22B is separated from the downstream side individual electrode 12B to pressurize the liquid, and at the same time, the upstream side vibrating plate 22A is separated from the upstream side individual electrode 12A. A force of the restoring pressure is usually applied not only in a direction toward the nozzles 31 but also in a direction toward the reservoir 24. In Mode 3, the upstream side vibrating plate 22A is brought into contact with the upstream side individual electrode 12A in advance. Then the upstream side vibrating plate 22A and the downstream side vibrating plate 22B are separated at a time so as to cancel the restoring pressure that is generated by the downstream side vibrating plate 22B and applied in the direction toward the reservoir 24 by the restoring pressure that is generated by the upstream side vibrating plate 22A and applied in the direction toward the nozzles 31. Thus, the liquid is prevented from flowing from the downstream side discharge chamber 21B into the upstream side discharge chamber 21A (counter flow) so as to turn the force toward the nozzles 31, increasing the discharge amount compared to that in Mode 2.

Mode 4

Electrostatic force is generated between the upstream side individual electrode 12A and the upstream side vibrating plate 22A and between the downstream side individual electrode 12B and the downstream side vibrating plate 22B so as to bring the upstream side vibrating plate 22A into contact with the upstream side individual electrode 12A and bring the downstream side vibrating plate 22B into contact with the downstream side individual electrode 12B. Then the upstream side vibrating plate 22A and the downstream side vibrating plate 22B are separated respectively from the upstream side individual electrode 12A and the downstream side individual electrode 12B so as to pressurize the liquid. The restoring pressure of the upstream side vibrating plate 22A is not used for preventing the counter flow of the liquid unlike Mode 3, but is actively used for discharging the liquid from the nozzles 31, increasing the discharge amount compared to Mode 3. Here, the upstream side vibrating plate 22A and the downstream side vibrating plate 22B may be separated at a time. However, they may be controlled such that the downstream side vibrating plate 22B is separated slightly earlier, for example, depending on a desired discharge amount corresponding to a type of the liquid, an applied voltage, and the like.

Mode 5

Electrostatic force is generated between the downstream side individual electrode 12B and the downstream side vibrating plate 22B so as to bring the downstream side vibrating plate 22B into contact with the downstream side individual electrode 12B and the state is kept. At this time, since the bulk of the downstream side discharge chamber 21B increases, the liquid is supplied from the reservoir 24 through the upstream side discharge chamber 21A. Then electrostatic force is generated between the upstream side individual electrode 12A and the upstream side vibrating plate 22A so as to bring the upstream side vibrating plate 22A into contact with the upstream side individual electrode 12A. After that, the upstream side vibrating plate 22A and the downstream side vibrating plate 22B are separated respectively from the upstream side individual electrode 12A and the downstream side individual electrode 12B so as to pressurize the liquid. In addition to the liquid supply corresponding to the increase of the bulk of the downstream side discharge chamber 21B, the liquid is discharged by the pressurization of the upstream side vibrating plate 22A and the downstream side vibrating plate 22B, increasing the discharge amount at a maximum among the five modes. Here, the upstream side vibrating plate 22A and the downstream side vibrating plate 22B are separated at a time, but they may be controlled depending on a desired discharge amount.

Next, a control of a vibration generated in the liquid by the upstream side vibrating plate 22A will be described. For example, after the vibrating plates 22 separate from the individual electrodes 12 and the liquid is pressurized, the vibrating plates 22 freely vibrate such that the vibrating plates 22 attenuate an overshoot while repeating it to return to the original position finally. Vibration (hereinafter, referred to as residual vibration) other than a displacement for returning to the original position is not necessary for discharging a droplet and affects adversely to an operation in the next period and a discharge by other adjacent nozzles. Therefore, the residual vibration is to be suppressed.

If the vibrating plates 22 that have pressurized the liquid separate from the individual electrodes 12 farther than the original position due to the overshoot, the electrostatic force rapidly decreases. Thus the control becomes hard. Therefore, in a case where only one vibrating plate 22 is provided, it is hard to conduct the residual vibration control with respect to the vibrating plate 22 overshooting.

While two vibrating plates 22 are provided on a flow channel to the nozzle 31 in this embodiment, in a case where the upstream side vibrating plate 22A does not pressurize for discharging like Mode 1 and Mode 2, the upstream side vibrating plate 22A does not overshoot. Therefore, after the downstream side vibrating plate 22B pressurizes the liquid, the upstream side vibrating plate 22A is controlled to be displaced and thus pressurizes the liquid so as to suppress the vibration (natural vibration) of the liquid within the downstream discharge chamber 21A, suppressing the residual vibration.

According to the droplet discharge head of the first embodiment, the upstream side discharge chamber 21A and the downstream side discharge chamber 21B are arranged in series on the flow channel corresponding to each of the nozzles 31. Electrostatic force is controlled to be generated and stopped individually between the upstream side vibrating plate 22A in the upstream side discharge chamber 21A and the individual electrode 12A and between the downstream side vibrating plate 22B in the downstream side discharge chamber 21B and the downstream side individual electrode 12B. Thus the upstream side vibrating plate 22A and the downstream side vibrating plate 22B are controlled to contact and separate at a predetermined timing individually, being able to change the discharge amounts of the droplet discharged from the nozzles 31. Thus a plurality of discharge amounts can be controlled at one discharge. The droplet discharge head arranges timings of contact and separate of two vibrating plates 22 so as to pressurize a liquid by the two vibrating plates 22 and draw in the liquid to be discharged. Thus the variation of the discharge amounts can be increased and the range of the change can be widened. The present embodiment makes removing volumes of the upstream side vibrating plate 22A and the downstream side vibrating plate 22B different. Especially, since the removing volume of the downstream side vibrating plate 22B is smaller than that of the upstream side vibrating plate 22A, the range of the change can be further widened.

Since the droplet discharge head includes a plurality of vibrating plates 22, electrostatic force for suppressing the residual vibration can be efficiently generated on the upstream side vibrating plate 22 that is not in an overshooting state, for example. Thus the residual vibration can be efficiently suppressed. The residual vibration can be suppressed and the vibrating plates 22 can quickly return to an equilibrium state, so that the driving frequency can be increased (the driving period is shorten), achieving the speed up and the like. Further, the liquid stored in the discharge chamber 21 is not pressurized and discharged, or the liquid or vibration within the discharge chamber 21 that is on a flow channel of other nozzles 31 is not adversely affected by the residual vibration.

### Second Embodiment

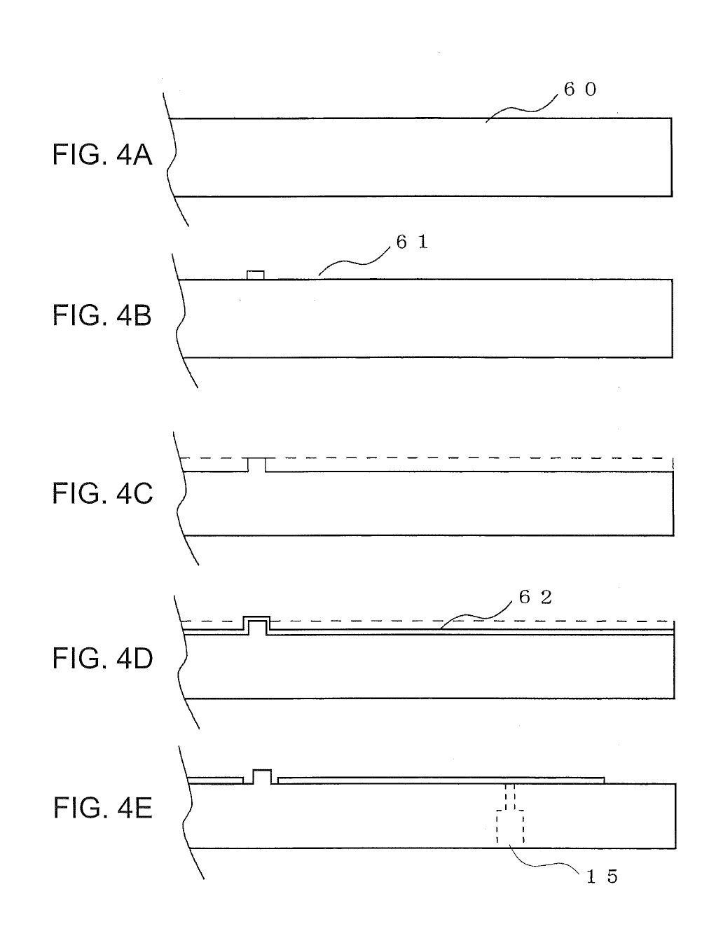

FIGS. 4A to 4E are diagrams showing an example of a forming process of the electrode substrate 10. The second embodiment will describe a method for manufacturing a droplet discharge head. First, forming steps of the electrode substrate 10 will be described with reference to FIGS. 4A to 4E. Here, in an actual process for manufacturing a droplet discharge head, a plurality of substrates such as electrode substrates 10 is formed at a time in a wafer unit, and the wafer is cut into pieces after bonded to other substrates, for example, producing a droplet discharge head. However, the drawings show a section obtained by cutting a part of one droplet discharge head in a longitudinal direction.

First, both surfaces of a glass substrate 60 having a thickness of 2 to 3 mm is ground by machine, etching, or the like so as to obtain the substrate 60 having the thickness of about 1 mm, for example. Then the glass substrate 60 is etched by 10 to 20 μm so as to remove a work altered layer (refer to FIG. 4A), for example. The work altered layer may be removed by dry-etching with SF₆ and the like, and spin-etching with a hydrofluoric acid solution, for example. If dry-etching is employed, the work altered layer formed on one surface of the glass substrate 60 can be efficiently removed and a protection for the other surface is not required. If spin-etching (wet-etching) is employed, an amount of a required etchant is small and new etchant is constantly supplied, being able to conduct a stable etching.

A film to be an etching mask 61 made of chrome (Cr) is formed over one whole surface of the glass substrate 60 by sputtering, for example. Then a resist (not shown) is patterned correspondingly to a shape of a recess 11 on the surface of the etching mask 61 by photolithography and further wet-etching is conducted so as to expose the glass substrate 60 (refer to FIG. 4B). After that, the glass substrate 60 is wet-etched with, for example, a hydrofluoric acid solution such as a buffered hydrofluoric acid (BHF, hydrofluoric acid:ammonium fluoride=1:6) solution so as to form the recess 11 (refer to FIG. 4C).

Next, an indium tin oxide (ITO) film 62 having conductivity is formed on the whole surface, at a side on which the recess 11 is formed, of the glass substrate 60 by sputtering, for example (refer to FIG. 4D). Then the resist (not shown) is patterned by photolithography and the ITO film 62 is etched while being protected at a part to be individual electrodes 12. Further, a through hole to be a liquid supply inlet 15 is formed by sand blasting or a cutting process (refer to FIG. 4E). Through the above steps, the electrode substrate 10 is formed.

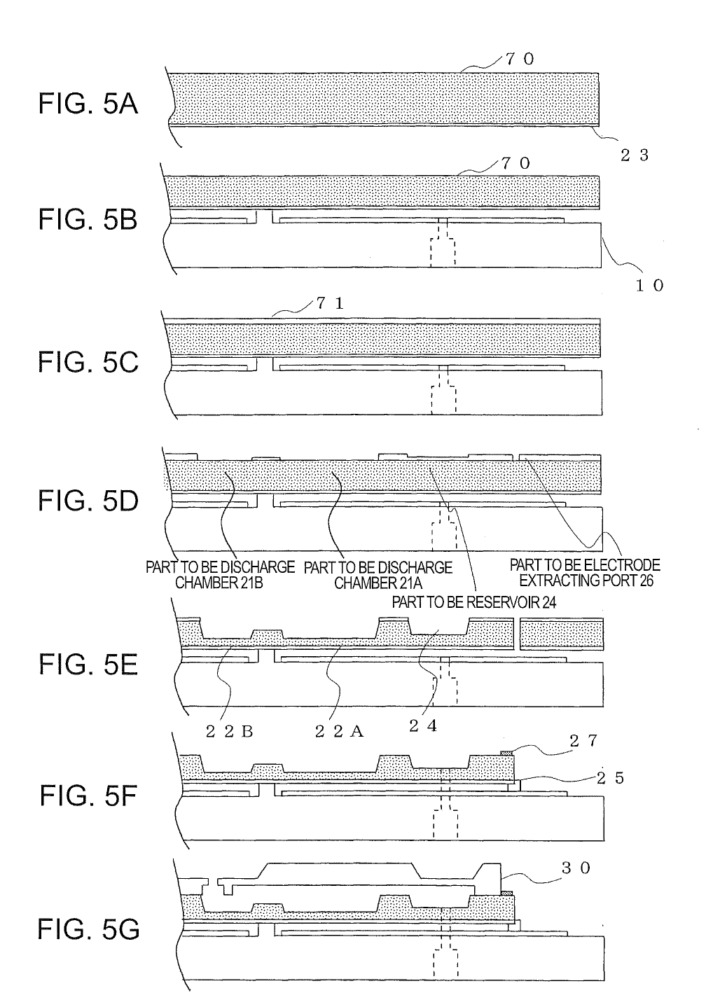

FIGS. 5A to 5G are diagrams showing a process for manufacturing a droplet discharge head. One surface of a silicon substrate 70 (to be a bonding surface to the electrode substrate 10) is mirror-polished so as to form a substrate (to be the cavity substrate 20) having a thickness of 220 μm, for example. The silicon substrate 70 is set in a vertical type furnace in a manner allowing its surface on which a boron-doped layer is to be formed to face a diffusion source of a substance primarily made of B₂O₃, diffusing boron in the silicon substrate 70. Thus a highly boron-doped layer (about 5×10¹⁹ atoms/cm³) is formed. Then an insulating layer 23 having a thickness of 0.1 μm is formed on the surface provided with the boron-doped layer by, for example, a plasma CVD method under the following conditions: processing temperature of 360° C.; high frequency output of 250 W; pressure of 66.7 Pa (0.5 Torr); TEOS flow rate of 100 cm³/min (100 sccm); and oxygen flow rate of 1000 cm³/min. (1000 sccm) (refer to FIG. 5A).

After the silicon substrate 70 and the electrode substrate 10 are heated at 360° C., an anodic bonding is conducted such that the electrode substrate 10 is connected to an negative pole while the silicon substrate 70 is connected to a positive pole, and a voltage of 800V is applied. In the substrate after the anodic bonding is conducted (hereinafter, referred to as a bonded substrate), the surface of the silicon substrate 70 is ground so as the silicon substrate 70 to have a thickness of about 60 μm. Then, the silicon substrate 70 is wet-etched by about 10 μm with a potassium hydrate aqueous solution having a concentration of 32 wt % so as to remove a work-altered layer. Accordingly the silicon substrate 70 has a thickness of about 50 μm (refer to FIG. 5B).

Next, an etching mask made of TEOS (hereinafter, referred to as a TEOS etching mask) 71 is formed on the surface that is wet-etched, by a plasma CVD method. The TEOS etching mask 71 having a thickness of 1.0 μm is formed under the following conditions: processing temperature of 360° C.; high frequency output of 700 W; pressure of 33.3 Pa (0.25 Torr); TEOS flow rate is 100 cm³/min. (100 sccm); and oxygen flow rate of 1000 cm³/min. (1000 sccm). The forming with TEOS can be conducted at relatively low temperature, so that heating of a substrate can be suppressed as much as possible, being suitable.

Resist patterning is conducted so as to etch a part of the TEOS etching mask 71. The part is to be the upstream side discharge chamber 21A, the downstream side discharge chamber 21B, and the electrode extracting port 26. The TEOS etching mask 71 is patterned such that the part thereof is etched with a hydrofluoric acid solution until the TEOS etching mask 71 is completely removed at the part, exposing the silicon substrate 70. After the etching, the resist is peeled off. Here, in terms of the part to be the electrode extracting port 26, the whole of the silicon does not have to be exposed, but a part to be a border between the electrode extracting port 26 and the cavity substrate 20, for example, is exposed and the rest part is left in an island shape so as to prevent a crack of the silicon.

Further, resist patterning is conducted so as to half-etch the TEOS etching mask 71 in a part to be a flow channel between the upstream side discharge chamber 21A and the downstream side discharge chamber 21B and a part to be the reservoir 24. Then the TEOS etching mask 71 in the parts is patterned by etching by about 0.7 μm, for example, with the hydrofluoric acid solution. Accordingly, the TEOS etching mask 71 in the part to be the flow channel between the upstream side discharge chamber 21A and the downstream side discharge chamber 21B and the part to be the reservoir 24 has a thickness of about 0.3 μm, exposing no silicon substrate 70. Though the thickness of the parts of the TEOS etching mask 71 that is left is about 0.3 μm, the thickness is need to be adjusted depending on a size of a desired flow channel and a depth of the reservoir 24. After the etching, the resist is peeled off (refer to FIG. 5D).

Next, the bonded substrate is soaked in a potassium hydrate aqueous solution having a concentration of 35 wt % so as to conduct wet-etching until the thicknesses of the part to be the discharge chambers 21 and the part exposing the silicon and to be the electrode extracting port 26 become about 10 μm. Then the bonded substrate is soaked in the hydrofluoric acid aqueous solution so as to etch and remove the TEOS etching mask 71 in the part to be the reservoir 24. Further the bonded substrate is soaked in a potassium hydrate aqueous solution having a concentration of 3 wt % so as to etch the boron-doped layer until the etching stop starts to sufficiently work. Etching with two potassium hydrate aqueous solutions having different concentrations from each other as above can suppress the surface roughness and improve the thickness accuracy of the vibrating plates 22 that are to be formed. Consequently, the discharge performance of the droplet discharge head can be stabilized (refer to FIG. 5E).

After the wet-etching is completed, the bonded substrate is soaked in a hydrofluoric acid solution so as to peel off the TEOS etching mask 71 formed on the surface of the silicon substrate 70. In order to remove the silicon of the silicon substrate 70 in a part to be the electrode extracting port 26, a silicon mask having an aperture corresponding to a part to be the electrode extracting port 26 is attached to the surface of the bonded substrate at a side of the silicon substrate 70. Then RIE dry-etching (anisotropic dry-etching) is conducted for two hours under the conditions: RF power of 200 W, pressure of 40 Pa (0.3 Torr), and CF₄ flow rate of 30 cm³/min (30 sccm), for example, and plasma is applied to only the part to be the electrode extracting port 26, opening the part. Because of the opening, a gap is opened to the atmosphere. Here, the silicon in the part to be the electrode extracting port 26 may be removed by picking with a pin and the like.

Then a sealing member 25 made of epoxy resin, for example, is poured along an edge of the electrode extracting port 26 (an aperture, formed between the cavity substrate 20 and the recess of the electrode substrate 10, of the gap) so as to seal the gap. A mask having an aperture corresponding to a part to be the common electrode terminal 27 is attached on the surface of the bonded substrate at a side of the silicon substrate 70. Then sputtering is conducted with respect to platinum (Pt) targeted, for example, so as to form the common electrode terminal 27. A through hole communicating a liquid supply inlet 15 and the reservoir 24 is formed in the silicon substrate 70. Here, in order to protect the cavity substrate 20 from the liquid flowing in the flow channel, a liquid protection film (not shown) made of oxide silicon, for example, may be formed. Accordingly, the processing treatment with respect to the bonded substrate is completed (refer to FIG. 5F).

The nozzle substrate 30 that have been formed and provided with a nozzle hole 31, a diaphragm 32, and an orifice 33 in advance is bonded on the bonded substrate at the cavity substrate 20 side with an epoxy adhesive. Then dicing is conducted to cut into pieces of droplet discharge head, completing the droplet discharge head that can operate as the first embodiment (refer to FIG. 5G).

### Third Embodiment

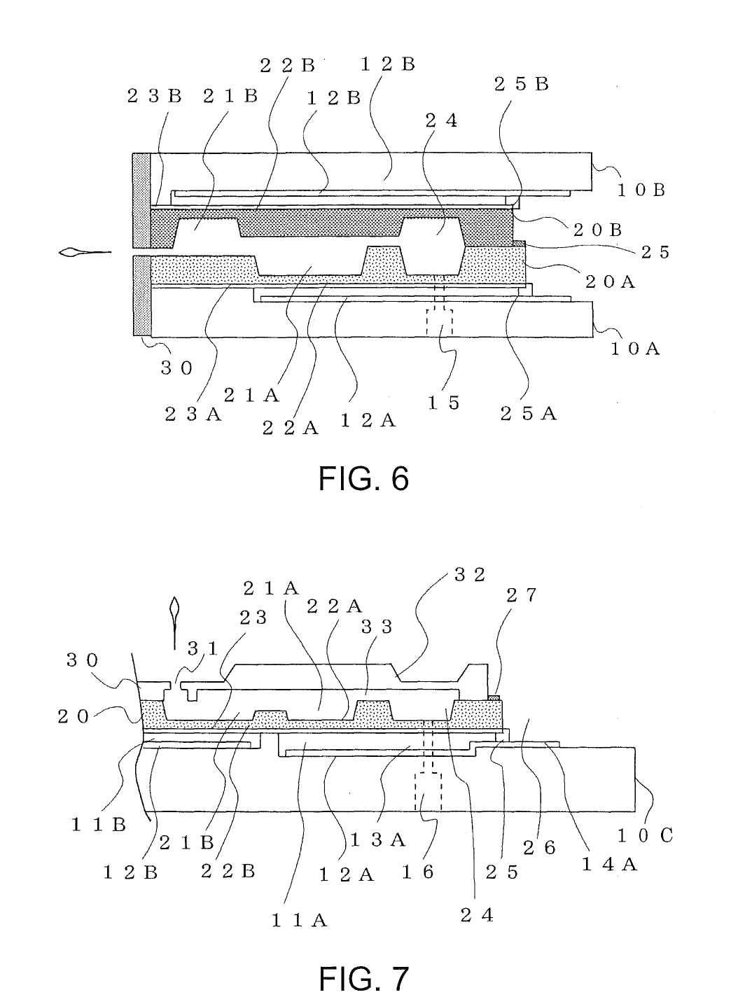

FIG. 6 is a sectional view showing a droplet discharge head according to a third embodiment. Elements, in FIG. 6, having the same reference numbers as those in the first and second embodiments operate in a similar way, so that the description thereof will be omitted. An upstream side electrode substrate 10A is provided with the upstream side individual electrode 12A described in the first embodiment. On the other hand, a downstream side electrode substrate 10B is provided with the downstream side individual electrode 12B. Here, it is enough to provide the liquid supply inlet 15 to one of the upstream side electrode substrate 10A and the downstream side electrode substrate 10B. The liquid supply inlet 15 is provided to the upstream side electrode substrate 10A in FIG. 6.

An upstream side cavity plate 20A includes a recess to be the upstream side discharge chamber 21A and the upstream side vibrating plate 22 that is a part of the recess as described in the first embodiment. Further, the upstream side cavity plate 20A includes an insulating film 23A on its surface opposed to the electrode substrate 10A. A sealing member 25 seals a gap.

On the other hand, a downstream side cavity plate 20B is provided with a recess to be the downstream side discharge chamber 21B and the downstream side vibrating plate 22B that is a part of the recess, as described in the first embodiment, in the same manner as the upstream side cavity plate 20A. An insulating film 23B is provided and a sealing member 25B seals a gap, as well.

In the present embodiment, a hole communicating with the nozzle 31A is formed by the upstream side cavity plate 20A and the downstream side cavity plate 20B at the edge face (lateral face) of the droplet discharge head. This hole may be a nozzle, but an applicable shape thereof is sometimes limited by a crystal plane orientation, for example. It is preferable that the nozzle has a circular cylinder or a circular cone shape so as to stabilize the discharge. Therefore, a nozzle plate 30A including the nozzle 31A that is formed in a predetermined shape in advance is provided to the edge face (lateral face) of the droplet discharge head.

The electrode substrate 10 described in the first embodiment is provided with the upstream side individual electrode 12A and the downstream side individual electrode 12B. However, since two individual electrodes 12 are wired with respect to one nozzle 31, a wiring density increases, sometimes making the wiring hard.

Therefore, the upstream side individual electrode 12A is formed on the upstream side electrode substrate 10A, and the downstream side individual electrode 12B is formed on the downstream side electrode substrate 10B in the present embodiment. The recess to be the upstream side discharge chamber 21A and the upstream side vibrating plate 22A are formed on the upstream side cavity plate 20A correspondingly to the upstream side individual electrode 12A. On the other hand, the recess to be the downstream side discharge chamber 21B and the downstream side vibrating plate 22B are formed on the downstream side cavity plate 20B correspondingly to the downstream side individual electrode 12B.

Then the upstream side electrode substrate 10A is arranged at a down side and the downstream side electrode substrate 10B is arranged at an up side in a manner allowing the upstream side cavity plate 21A and the downstream side cavity plate 21B to face each other. Since the upstream side electrode substrate 10A and the downstream side electrode substrate 10B are arranged up and down, the droplet discharge head of the present embodiment is not the face ejecting type like the first embodiment, but an edge ejecting type. The nozzle plate 30A including the nozzle 31A is provided to the lateral face of the head.

The droplet discharge head of the present embodiment is manufactured in the same manner as the second embodiment. The layered substrate of the upstream side electrode substrate 10A and the upstream side cavity plate 20A and the layered substrate of the downstream side electrode substrate 10B and the downstream side cavity plate 20B are formed by photolithography, etching, cutting, and the like. In forming recesses such as the discharge chambers 21, a flow channel for communicating with the nozzle 31A is also formed. Then the two layered substrates are bonded with an epoxy adhesive in a manner arranging the upstream side cavity plate 20A and the downstream side cavity plate 20B to be opposed. Then, the bonded substrate is diced into pieces of droplet discharge head.

In terms of forming the nozzle plate 30A, a silicon substrate is dry-etched so as to form a nozzle hole having a predetermined depth and a division groove for dividing the silicon substrate into pieces of nozzle plates. Then the silicon substrate is polished and the nozzle hole is allowed to penetrate the substrate so as to complete the nozzle 31A. The division groove formed together with the nozzle hole has the same depth, so that the substrate is divided into pieces of nozzle plate 30A in accompanied with the penetration of the nozzle hole. Then each piece of the nozzle plate 30A is bonded to a bonding substrate obtained by dicing with an epoxy adhesive, completing the droplet discharge head. Controls such as discharge amount control are the same as those of the first embodiment, so that a description thereof is omitted.

As described above, the droplet discharge head of the third embodiment includes two separate substrates such that the upstream side electrode substrate 10A is disposed at the down side and the downstream side electrode substrate 10B is disposed at the upper side. In addition, the upstream side discharge chamber 21A (the upstream side vibrating plate 22A) and the downstream side discharge chamber 21B (the downstream side vibrating plate 22B) are arranged tandemly. Therefore, the droplet discharge head having the same advantageous effect as the first embodiment can be miniaturized.

### Fourth Embodiment

FIG. 7 is a sectional view showing a droplet discharge head according to a fourth embodiment. In the present embodiment, an electrode substrate 10C includes a recess 11A and a recess 11B that have different depths from each other so as to make removing volumes differ from each other. Therefore, a gap between the upstream side individual electrode 12A and the upstream side vibrating plate 22A is different from a gap between the downstream side individual electrode 12B and the downstream side vibrating plate 22B. Accordingly, an amount of displacement of the upstream side vibrating plate 22A is different from that of the downstream side vibrating plate 22B, making the removing volumes different from each other. Especially, the removing volumes by the vibrating plates 22 can be made different while achieving the miniaturization of the droplet discharge head with no increase of the width and the length of the vibrating plates 22.

### Fifth Embodiment

While two discharge chambers 21, two vibrating plates 22, and two individual electrodes 12 are provided on the flow channel with respect to the nozzle 31 in the above embodiments, three discharge chambers 21, three vibrating plates 22, and three individual electrodes 12 may be provided.

The above embodiments describe the timing control of contact and separate of the vibrating plates 22 for suppressing the residual vibration and for changing the discharge amount. However, the invention is not limited to the above and other controls may be conducted.

### Sixth Embodiment

The above embodiments describe the droplet discharge head in which three substrates of the electrode substrate 10, the cavity substrate 20, and the nozzle substrate 30 are layered, but the invention is not limited to this. A droplet discharge head in which the discharge chambers 21 and the reservoir 24 are formed separately on different substrates and thus the four substrates are layered, for example, may be applied.

### Seventh Embodiment

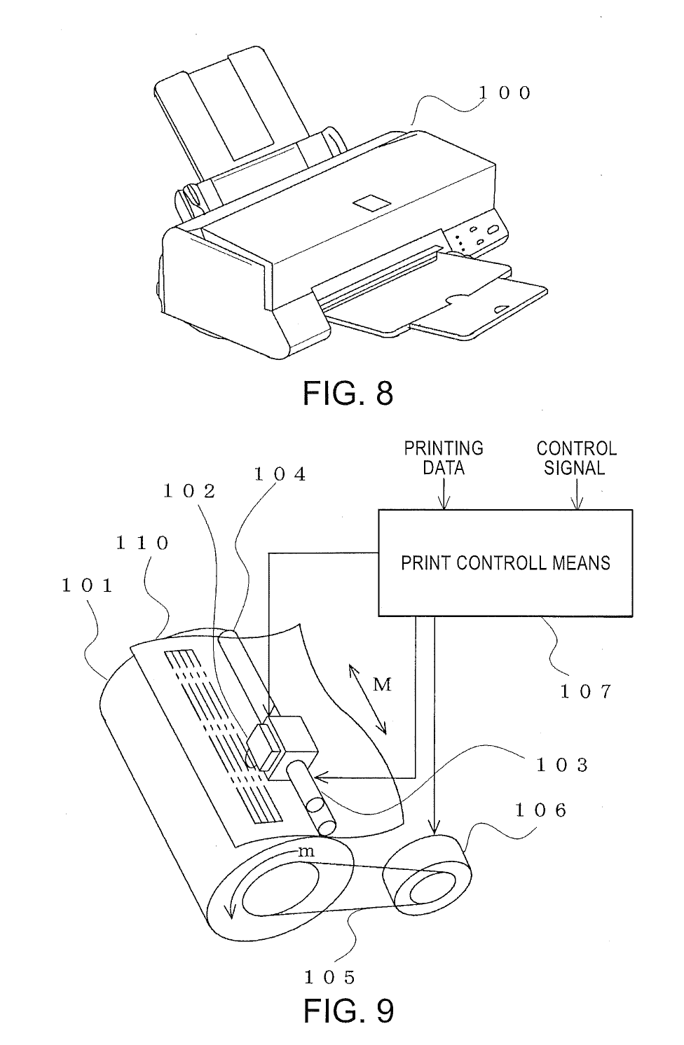

FIG. 8 is an external view showing a droplet discharge device (a printer 100) employing the droplet discharge head manufactured in the above embodiments. FIG. 9 is a diagram showing an example of a main structural means of the droplet discharge device. The droplet discharge device of FIGS. 8 and 9 prints by a droplet discharge method (an ink-jetting method). In addition, the droplet discharge device is in a serial type. As shown in FIG. 9, the droplet discharge device 100 mainly includes a drum 101 and a droplet discharge head 102. The drum 101 supports a print paper 110 that is an object to be printed. The droplet discharge head 1 discharges ink to the print paper 110 for performing a record. In addition, ink supply means (not shown) is provided for supplying ink to the droplet discharge head 102. The print paper 110 is pressed and held to the drum 101 by a paper pressing-holding roller 103 disposed in parallel to the axial direction of the drum 101. In parallel to the axial direction of the drum 101, a lead screw 104 is disposed to hold the droplet discharge head 102. By rotating the lead screw 104, the droplet discharge head 102 moves in the axial direction of the drum 101.

On the other hand, the drum 101 is rotary driven by a motor 106 with a belt 105 and the like. The driving control circuit 40 drives the lead screw 104 and the motor 106 in accordance with printing data and a control signal. Though the figure does not show here, as described in the first embodiment, arbitrary voltage is applied to each of the individual electrodes 12A, 12B from the driver IC 48 while controlling the charge supply so as to vibrate each of the vibrating plates 22. Thus the device prints on the print paper 110 while controlling.

While liquid is discharged to the print paper 110 as ink in this case, liquid discharged from the droplet discharge head is not limited to ink. A variety of liquid may be discharged from a droplet discharge head provided in respective apparatuses used in the following exemplary cases. In an application where liquid is discharged to a substrate serving as a color filter, liquid containing a pigment may be used. In another application where liquid is discharged to a substrate serving as a display panel (such as OLED) using an electroluminescent element such as an organic compound, liquid containing a compound serving as an light-emitting element may be used. In another application where liquid is discharged on a substrate for forming wire lines, liquid containing conductive metal may be used. When liquid is discharged to a substrate serving as a biomolecule micro array, liquid may be discharged that contains a probe of, for example, deoxyribonucleic acids (DNA), other nucleic acids such as ribonucleic acids and peptide nucleic acids, and other proteins, by using the droplet discharge head as a dispenser. The device also can be used to discharge a dye for clothes or the like.

What is claimed is:

1. A droplet discharge head, comprising:
a nozzle;
a plurality of discharge chambers each of which is provided with a respective one of a plurality of vibrating plates to be displaced so as to pressurize a liquid, and formed in series in a flow channel of the liquid, the flow channel communicating with the nozzle; and
a fixed electrode that is opposed to each of the vibrating plates of each of the discharge chambers and generates an electrostatic force for displacing each of the vibrating plates, wherein
removing volumes removed by the displacement of the vibrating plates are different from each other.

2. The droplet discharge head according to claim 1, wherein the fixed electrode is provided in a plurality of numbers, and each of the fixed electrodes is wired individually and is opposed to each of the vibrating plates.

3. The droplet discharge head according to claim 2, wherein two substrates on which the plurality of fixed electrodes are divided to be provided are each bonded on both surfaces of a substrate provided with the plurality of discharge chambers.

4. The droplet discharge head according to claim 3, wherein the nozzle is provided to an edge face of the head.

5. The droplet discharge head according to claim 1, wherein a removing volume removed by the displacement of a vibrating plate that is formed at a closer side to the nozzle is smaller.

6. The droplet discharge head according to claim 1, wherein the vibrating plates are allowed to have at least one of different lengths and different widths from each other so as to make removing volumes removed by the displacement of the vibrating plates different from each other.

7. The droplet discharge head according to claim 2, wherein gaps between the vibrating plates and the fixed electrodes are formed to differ from each other at an initial state and thus removing volumes removed by the displacement of the vibrating plates are made different from each other.

8. A droplet discharge device, comprising the droplet discharge head of claim 1.

9. A method for controlling a discharge of a droplet discharge head, the droplet discharge head including: two discharge chambers that are provided in series in a flow channel communicating with a nozzle and are provided with respective one of two vibrating plates to be displaced to pressurize a liquid; and two fixed electrodes generating an electrostatic force based on a potential difference and displacing the two vibrating plates having different removing volumes removed by a displacement so as to pressurize the liquid, the method comprising
a) generating an electrostatic force between a downstream side vibrating plate that is closer to the nozzle and is one of the vibrating plates each included to the two discharge chambers and a downstream side fixed electrode so as to apply a pressure for discharging a droplet; and
b) generating an electrostatic force between an upstream side vibrating plate that is the other vibrating plate and an upstream side fixed electrode, and thus drawing the upstream side vibrating plate toward the upstream side fixed electrode so as to draw a posterior end of the liquid to be discharged from the nozzle as a droplet into the flow channel.

10. A method for controlling a discharge of a droplet discharge head, the droplet discharge head including: two discharge chambers that are provided in series in a flow channel communicating with a nozzle and are provided with respective one of two vibrating plates to be displaced to pressurize a liquid; and two fixed electrodes generating an electrostatic force based on a potential difference and displacing the two vibrating plates having different removing volumes removed by a displacement so as to pressurize the liquid, the method comprising:
c) drawing an upstream side vibrating plate that is farther from the nozzle and is one of the vibrating plates each included to the two discharge chambers toward an upstream side fixed electrode, and keeping the state; and
d) generating an electrostatic force between a downstream vibrating plate that is the other vibrating plate and a downstream side fixed electrode, and thus drawing the downstream side vibrating plate toward the downstream side fixed electrode so as to apply a pressure for discharging a droplet by the downstream side vibrating plate and an upstream side vibrating plate.

11. A method for controlling a discharge of a droplet discharge head, the droplet discharge head including: two discharge chambers that are provided in series on a flow channel communicating with a nozzle and are provided with respective one of two vibrating plates to be displaced to pressurize a liquid; and two fixed electrodes generating an electrostatic force based on a potential difference and displacing the two vibrating plates having different removing volumes removed by a displacement so as to pressurize the liquid, the method comprising:
e) drawing a downstream side vibrating plate that is closer the nozzle and is one of the vibrating plates each included to the two discharge chambers toward a downstream side fixed electrode so as to increase a bulk of the downstream side discharge chamber, and keeping this state until a liquid is supplied to the downstream side discharge chamber; and
f) generating an electrostatic force between an upstream vibrating plate that is the other vibrating plate and an upstream side fixed electrode, and thus drawing the upstream side vibrating plate toward the upstream side fixed electrode so as to apply a pressure for discharging a droplet by the downstream side vibrating plate and the upstream side vibrating plate.

12. A method for controlling a discharge of a droplet discharge head, the droplet discharge head including: two discharge chambers that are provided in series on a flow channel communicating with a nozzle and are provided with respective one of two vibrating plates to be displaced to pressurize a liquid; and two fixed electrodes generating an electrostatic force based on a potential difference and displacing the two vibrating plates having different removing volumes removed by a displacement so as to pressurize the liquid, the method comprising:
g) generating an electrostatic force between a downstream side vibrating plate that is closer to the nozzle and is one of the two vibrating plates each included to the two discharge chambers and a downstream side fixed electrode so as to apply a pressure for discharging a droplet; and
h) generating an electrostatic force between an upstream side vibrating plate that is the other vibrating plate and an upstream side fixed electrode after a droplet is discharged from the nozzle so as to generate a vibration, the vibration canceling a natural vibration of the liquid in the flow channel, on the upstream side vibrating plate.

13. A method for controlling a discharge of a droplet discharge device, comprising controlling a discharge by applying the method for controlling a discharge of a droplet discharge head according to claim 9.
